(19) United States
(12) Patent Application Publication
(10) Pub. No.: US 2017/0363216 A1
(43) Pub. Date: Dec. 21, 2017

(54) Fluid Valve With Multiple Inlets And Outlet

(71) Applicant: EMERSON ELECTRIC CO., St. Louis, MO (US)

(72) Inventors: Matthew A. SCHMITT, Kenosha, WI (US); Peter J. LOIRE, Genoa, WI (US)

(73) Assignee: Emerson Electric Co., St. Louis, MO (US)

(21) Appl. No.: 15/537,174

(22) PCT Filed: Dec. 16, 2015
(86) PCT No.: PCT/US2015/066078

§ 371 Date: Jun. 16, 2017

Related U.S. Application Data
(60) Provisional application No. 62/093,014, filed on Dec. 17, 2014.

(51) Int. Cl. F16K 11/078; E03C 1/04; F16K 11/074; E03C 1/02

(52) U.S. Cl. CPC F16K 11/0787; F16K 11/0746; E03C 1/04; F16K 11/0743; E03C 2001/026

(57) ABSTRACT

A multi-flow valve has an in-let/outlet plate (208) with at least two inlet openings (210, 212) and two outlet openings (214, 216). A fluid flow selector (206) has a fluid passage (228) therein. The fluid flow selector is rotatable with respect to the inlet/outlet plate among a closed position a first open position and a second open position. When in the first open position the fluid flow passage fluidly couples the first inlet to the first outlet and when in the second open position the fluid passage fluidly couples the second inlet to the second outlet. In an aspect, when the fluid flow selector is in the closed position the fluid flow passage fluidly couples the first outlet to the second outlet. In an aspect, the fluid flow passage is an offset arcuate channel.

### CROSS-REFERENCE TO RELATED APPLICATIONS

This application claims the benefit of U.S. Provisional Application No. 62/093,014 filed Dec. 17, 2014. The entire disclosure of the above application is incorporated herein by reference.

### FIELD

The present disclosure relates to valves for faucets.

### BACKGROUND

This section provides background information related to the present disclosure which is not necessarily prior art.

Valves and valve cartridges have been used in plumbing fittings such as for faucets for years. Cartridge style valves allow for a fluid control mechanism to be packaged into a discrete unit that can then be easily designed into plumbing fittings. With respect to plumbing fitting design, the cartridge valve allows for reduced development time/cost and improved reliability by standardizing the valve design from fitting to fitting.

The typical valve cartridges on the market today used for standard kitchen and bath plumbing fittings (e.g., faucets and shower systems) are: mixing valves having two inlets and one outlet; diverting valves having one inlet and multiple outlets and on/off valves having one inlet and one outlet. The first combines fluid from two discrete supply lines into outlet flow. The second takes one flow path and diverts or split the path into several different paths. The third simply acts as a basic shut-off valve. These designs however do not meet the requirements of a valve for a single handle, two inlet/two outlet configuration. Further, specialty applications may require differing flow rates based on the application. The above described valves limit flow by the degree to which the valve is open, typically determined by the position of the handle used to open and close and valve. Any additional flow control that may be needed is then done externally of the valve.

Heretofore, when there has been a need for a two inlet/two outlet configuration this has been accomplished by using two discrete valves with each valve having its own handle or by using a single inlet/two outlet diverting valve. The former results in higher cost products due to the need for two handles and two valves as well as limiting available design options due to the need for the two handles. The latter results in only a single supply line, and thus restricts the design to working with only one fluid source. For example, in a hot water dispenser having a faucet with a cold water outlet, if it is desired that the water exiting the cold water outlet be chilled, the water must first be chilled and supplied to the faucet. With the diverting valve, when handle is moved to the hot water side, the cold water flows into the heating tank reducing the water temperature and efficiency of the tank.

Cartridge valves, while offering many advantages, often cost more than placing discrete parts into plumbing fittings.

Current valve cartridges come in flow rates published by the manufactures. For applications not fitting with the standard kitchen/bath faucets, flow controls must be added internal to the faucet to obtain the flow rates required. Alternatively, custom valves and faucets are designed for each application to obtain the flow rates required. This however limits the ability to change the flow rate of a faucet after it has been produced or requires additional components in the design.

### SUMMARY

This section provides a general summary of the disclosure, and is not a comprehensive disclosure of its full scope or all of its features.

In accordance with an aspect of the present disclosure, a multi-flow valve has first and second discrete fluid inlets and first and second discrete fluid outlets. The valve has a normally closed position and first and second open positions. When the valve is in the normally closed position, fluid is blocked from flowing from the inlets to the outlets. When the valve is in the first open position, it couples a flow passage between the first inlet and the first outlet and fluid flows from the first inlet to the first outlet. When the valve is in the second open position, it couples the flow passage between the second inlet and the second outlet and fluid flows from the second inlet to the second outlet.

In an aspect, the valve is also configured to regulate the flow rate of fluid flowing through the valve. In an aspect, the valve inlets and/or outlets are configured for use of interchangeable orifice members thereat. Orifices in the orifice members that are used have openings that are sized to provide the desired flow rate for a particular application.

In an aspect, the multi-flow valve has a valve housing in which a spindle, a fluid flow selector and an inlet/outlet plate are received and a surface plate affixed to a proximal end of the valve housing abutting a proximal side of the inlet/outlet plate and a distal side of the inlet/outlet plate abutting a proximal side of the fluid flow selector plate. The inlet/outlet plate has first and second inlet openings and first and second outlet openings with the surface plate having corresponding inlet openings and outlet openings fluidly coupled to the corresponding first and second inlet openings and first and second outlet openings of the inlet/outlet plate. A fluid flow selector has a fluid flow passage therein. The fluid flow selector is rotatable with respect to the inlet/outlet plate among a plurality of rotational positions. The rotational positions include a closed position, a first open position and a second open position. The fluid flow passage bridges across only the first inlet opening to the first outlet opening when the fluid flow selector is in the first open position to fluidly couple the first inlet opening to the first outlet opening. The fluid flow selector bridges across only the second inlet opening to the second outlet opening to fluidly couple the second inlet opening to the second outlet opening when the fluid flow selector is in the second open position. The fluid flow passage does not bridge across the first inlet to the first outlet and or across the second inlet to the second outlet when the fluid flow selector is in the closed position.

In an aspect, the fluid flow selector is a fluid flow selector plate and the fluid flow passage is an offset arcuate channel in the fluid flow selector plate that is offset from a center of the fluid flow selector plate and that lies in an arc in which the first and second inlet openings and the first and second outlet openings of the inlet/outlet plate are disposed.

In an aspect, the offset arcuate channel bridges across the first outlet opening to the second outlet opening to fluidly couple the first outlet opening to the second outlet opening when the fluid flow selector is in the closed position.

In an aspect, a water dispenser includes a faucet spout and a multi-flow valve in accordance with any of the above aspects. In this aspect, the first outlet opening of the surface plate is fluidly coupled to a first outlet line of the faucet spout and the second outlet opening of the surface plate is fluidly coupled to a second outlet line of the faucet spout. In a variation, the second outlet opening is fluidly coupled to the first outlet line and the second outlet line is dispensed with. In an aspect, the first inlet opening is coupled to a source of water and the second inlet opening is coupled to a different source of water. In an aspect, the sources of water are hot and cold tap water. In an aspect, the sources of water are sources of conditioned water.

In an aspect, the inlet/outlet plate includes third and fourth inlet openings and a mixed flow outlet opening. The fluid flow selector is a fluid flow selector plate having a mixed flow fluid passage that is an elongate central channel in the fluid flow selector plate. The fluid flow selector plate is movable radially with respect to the inlet/outlet plate among at least an auxiliary flow position, a neutral flow position and a mixed-flow position. The offset arcuate channel of the fluid flow selector plate lies in the arc in which the first and second inlet openings and the first and second outlet openings lie when the fluid flow selector plate is in the auxiliary flow position and the offset arcuate channel does not lie in this arc when the fluid flow selector plate is not in the auxiliary flow position and when the fluid flow selector plate is not in the auxiliary flow position the offset arcuate channel does not fluidly couple the first inlet opening to the first outlet opening, the second fluid opening to the second outlet opening or the first outlet opening to the second outlet opening regardless of the rotational position of the fluid flow selector plate. The plurality of rotational positions among which the fluid flow selector plate can be rotated when the fluid flow selector plate is in the mixed flow position include a mixed flow on position in which a section of the elongate channel extends over the third and fourth fluid inlets and the elongate channel bridges across and the third and fourth fluid inlets to the mixed flow outlet opening to fluidly couple the third and fourth fluid inlets to the mixed flow outlet, a third flow on position in which the section of the elongate channel extends over the third inlet opening and the elongate channel bridges across the third fluid inlet opening and the mixed flow outlet opening to fluidly couple the third fluid inlet opening to the mixed flow outlet opening but does not bridge across the fourth flow inlet to the mixed flow outlet opening, and a fourth flow on position in which the section of the elongate channel extends over the fourth inlet opening and the elongate channel bridges across the fourth inlet opening to the mixed flow outlet opening to fluidly couple the fourth inlet opening to the mixed flow outlet opening but does not bridge across the third inlet opening to the mixed flow outlet opening. When the fluid selector plate is in the neutral flow position none of the inlet openings and outlet openings are fluidly coupled to each other regardless of the rotational position of the fluid selector plate.

In an aspect, the mixed flow position includes a plurality of mixed flow positions including a mixed flow-low volume position and a mixed flow-high volume position. When the fluid flow selector plate is in the mixed flow-high volume position a larger section of the elongate channel extends over those of the third and fourth inlet openings to which the fluid flow selector plate has been rotated to extend over than when the fluid flow selector plate is in the mixed flow-low volume position.

In an aspect, the inlet/outlet plate includes third and fourth inlet openings and a mixed flow outlet opening and the multi-flow valve is a four inlet/three outlet multi-flow valve. The fluid flow selector plate includes inner and outer concentric disks that are each rotatable independently of each other with respect to the inlet/outlet plate. The outer concentric disk has the arcuate offset channel therein and the inner concentric disk has a mixed flow fluid passage that is an elongate central channel in the fluid flow selector plate. At least the inner concentric disk is movable radially with respect to the inlet/outlet plate among at least a neutral flow position and a mixed-flow position. The plurality of rotational positions among which the fluid flow selector plate can be rotated when the inner concentric disk is in the mixed flow position includes a mixed flow on position in which a section of the elongate channel extends over the third and fourth fluid inlets and the elongate channel bridges across and the third and fourth fluid inlets to the mixed flow outlet opening to fluidly couple the third and fourth fluid inlets to the mixed flow outlet, a third flow on position in which the section of the elongate channel extends over the third inlet opening and the elongate channel bridges across the third fluid inlet opening and the mixed flow outlet opening to fluidly couple the third fluid inlet opening to the mixed flow outlet opening and does not bridge across the fourth flow inlet to the mixed flow outlet opening and a fourth flow on position in which the section of the elongate channel extends over the fourth inlet opening and the elongate channel bridges across the fourth inlet opening to the mixed flow outlet to fluidly couple the fourth inlet opening to the mixed flow outlet opening but does not bridge across the third inlet opening to the mixed flow outlet opening. When the inner concentric disk is in the neutral flow position neither of the third and fourth inlet openings are fluidly coupled to the mixed flow outlet opening regardless of the rotational position of the fluid selector plate.

In an aspect, the mixed flow position includes a plurality of mixed flow positions including a mixed flow-low volume position and a mixed flow-high volume position. When the inner concentric disk is in the mixed flow-high volume position a larger section of the elongate channel extends over those of the third and fourth inlet openings to which the inner concentric disk has been rotated to extend over than when the inner concentric disk is in the mixed flow-low volume position.

In an aspect, the four inlet/three outlet multi-flow valve is changed to a three inlet/two outlet multi-flow valve by replacing its inlet/outlet plate with an inlet/outlet plate that does not have the second inlet opening and the second outlet opening.

In an aspect, a water dispenser includes a conditioned water source, a faucet spout and a multi-flow valve in accordance with any of the above aspects. The first and second inlet openings of the surface plate provide first and second inlets of the valve and the first and second outlet openings of the surface plate provide first and second outlets of the valve. The first outlet of the multi-flow valve is fluidly coupled to the conditioned water source. The second outlet of the valve is fluidly coupled to an outlet line of the faucet spout. An outlet of the conditioned water source is fluidly coupled to the outlet line of the faucet spout through a check valve. In an aspect, the second outlet of the valve is alternatively fluidly coupled to another outlet line of the faucet instead of the outlet line to which the outlet of the conditioned water source is fluidly coupled. In an aspect, the water dispenser can be a water dispenser of any of hot water, chilled water, filtered water, distilled water, deionized water, reverse osmosis water, carbonated water, or other types of conditioned water and the water source is a source of the conditioned water.

In an aspect, the water dispenser is a hot water dispenser with the water source being a heated tank and the hot water dispenser has a check valve through which the outlet of the water source is fluidly coupled to the outlet line of the faucet. In an aspect, the faucet has a vent line fluidly coupled to the heated tank that is the source of conditioned water.

In an aspect, the water dispenser further includes a hot/cold water mixing valve and the faucet spout has a mixed water outlet line fluidly coupled to an outlet of hot/cold water mixing valve.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a basic schematic view of a multi-flow valve having two inlets and two outlets in accordance with an aspect of the present disclosure;

FIG. 2 is an exploded view of an example embodiment of the valve of FIG. 1;

FIG. 3 is a diagrammatic view of a conditioned water dispenser having the valve of FIG. 1;

FIG. 4 is a diagrammatic view of a water dispenser having the conditioned water dispenser of FIG. 3 and a hot/cold water mixing valve;

FIGS. 5A and 5B are exploded views of a four inlet/three outlet multi-flow valve in accordance with an aspect of the present disclosure;

FIGS. 6A-6D are diagrammatic views of the valve of FIGS. 5A and 5B in an auxiliary flow position;

FIGS. 7A-7D are diagrammatic views of the valve of FIGS. 5A and 5B in a neutral position;

FIGS. 8A-8D are diagrammatic views of the valve of FIGS. 5A and 5B in a mixed flow-low volume position;

FIGS. 9A-9D are diagrammatic views of the valve of FIGS. 5A and 5B in a mixed flow-high volume position are exploded views of a another multi-flow valve in accordance with an aspect of the present disclosure;

FIGS. 10A and 10B are exploded views of a another four inlet/three outlet multi-flow valve in accordance with an aspect of the present disclosure;

FIGS. 11A-11C are diagrammatic views of a variation of the valve of FIG. 2;

FIG. 12 is a diagrammatic view of a water dispenser having the valve of FIG. 1 in accordance with an aspect of the present disclosure;

FIG. 13 is a diagrammatic view of a water dispenser having the valve of either FIG. 5A, 5B or 10A, 10B in accordance with an aspect of the present disclosure; and

FIG. 14 is a variation of the inlet/outlet plate of the valves of FIGS. 5A, 5B and 10A, 10B changing those valves to three inlet/two outlet valves in accordance with an aspect of the present disclosure.

Corresponding reference numerals indicate corresponding parts throughout the several views of the drawings.

### DETAILED DESCRIPTION

Example embodiments will now be described more fully with reference to the accompanying drawings.

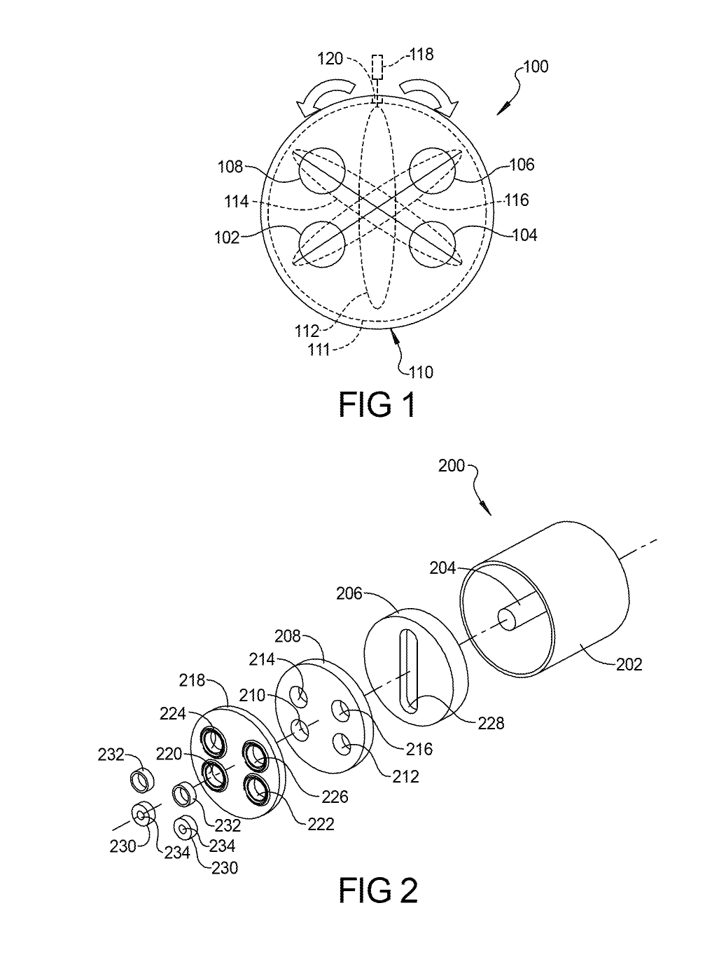

In accordance with an aspect of the present disclosure and with reference to FIG. 1 which is a basic schematic of a two inlet/two outlet valve 100 in accordance with an aspect of the present disclosure, a fluid valve 100 has two discrete fluid inlets, inlet 102 and inlet 104, and two discrete fluid outlets, outlet 106 and outlet 108. It should be understood that valve 100 can be a valve cartridge. Valve 100 has a normally closed position 112 and two open positions, open position 114 and open position 116. When valve 100 is in the normally closed position, fluid is blocked from flowing from inlets 102, 104 to outlets 106, 108. When valve 100 is in open position 114, it fluidly couples a flow passage between inlet 102 and outlet 106 allowing fluid to flow from inlet 102 to outlet 106 and fluid flow from inlet 104 to outlet 108 is blocked. When valve 100 is in open position 116, it fluidly couples the flow passage between inlet 104 and outlet 108 and fluid is allowed to flow from inlet 104 to outlet 108 and fluid flow from inlet 102 to outlet 106 is blocked. Regardless of the position of valve 100, fluid does not flow from inlet 102 to outlet 108 or from inlet 104 to outlet 106. Valve 100 provides for discrete fluid paths by which fluid from different sources can flow through the valve without the fluid from the different sources being mixed. When valve 100 is used in a kitchen or bath application, the different sources of fluid for example can include hot water, chilled water, filtered water, distilled water, deionized water, reverse osmosis water, carbonated water, and other types of water.

Valve 100 illustratively is coupled to a handle 118 that is moved to move the valve to its various positions.

In an aspect, valve 100 is also configured to regulate the flow rate of fluid flowing through it. In an aspect, valve inlets and/or outlets are configured for use of interchangeable orifice members thereat. Orifices in the orifice members that are used have openings that are sized to provide the desired flow rate for a particular application. This for example allows faucets to be manufactured with identical bodies, which allows standardization of faucets, but able to be configured to have different flow rates by the use of appropriately sized orifices at the inlets and/or outlets of the valve.

Valve 100 includes a movable flow passage member 110 having fluid flow passage 111 movable among closed position 112, open position 114 and open position 116. Movable flow passage member 110 is coupled to handle 118 that for example is moved clockwise (as oriented in FIG. 1) to move movable flow passage member 110 to open position 114 from closed position 112 and counterclockwise to move movable flow passage member 110 to open position 116 from closed position 112. When movable flow passage member 110 is in open position 116, inlet 102 is fluidly coupled to outlet 106 with outlet 106 by fluid flow passage 111 bridging across inlet 102 to outlet 106 allowing fluid to flow from inlet 102 to outlet 106 and fluid is blocked from flowing from inlet 104 to outlet 108. When movable flow passage member 110 is in open position 114, inlet 104 is fluidly coupled to outlet 108 by fluid flow passage 111 bridging across inlet 104 to outlet 108 allowing fluid to flow from inlet 104 to outlet 108 and fluid is blocked from flowing from inlet 102 to outlet 106. When movable flow passage member 110 is in closed position 112, fluid is blocked from flowing from inlets 102, 104 to outlets 106, 108, respectively. Further, regardless of the position of movable flow passage member 110, fluid is blocked from flowing from inlet 102 to outlet 106 or from inlet 104 to outlet 108. Valve 100 optionally includes a detent 120 shown in phantom in FIG. 1 at closed position 112. This detent may for example be a detent of the type conventionally used in certain prior art valve cartridges.

FIG. 2 shows a valve 200 that is an example embodiment of valve 100. Valve 200 includes a valve housing 202 having a spindle 204, a fluid flow selector plate 206 that provides movable flow passage member 110, an inlet/outlet plate 208 having inlet openings 210, 212 that provide inlets 102, 104 and outlet openings 214, 216 that provide outlets 106, 108, a surface plate 218 having inlet openings 220, 222 for inlets 102, 104 and outlet openings 224, 226 for outlets 106, 108. The fluid flow selector plate 206 includes an elongate channel 228 therein that provides a flow passage as described below. While not shown in FIG. 2, handle 118 is illustratively coupled to the fluid flow selector plate 206.

Interchangeable orifice members 230 are received in inlet openings 220, 222 of surface plate 218 and insert/seals 232 are received in outlet openings 224, 226 of surface plate 218. It should be understood that orifice members 230 can also be seals. It should also be understood that orifice members 230 could be received in outlet openings 224, 226 instead of insert/seals 232 in which case insert/seals 232 could be received in inlet openings 220, 222 instead of orifice members 230. It should be understood that orifice members 230 could be received in all of openings 220, 222, 224, 226. Orifice members 230 include orifices 234 therein which are sized to provide the desired flow rate of fluid through valve 200.

In operation, valve 200 is moved to the open position 116 (FIG. 1) by rotating fluid flow selector plate 206 clockwise and when valve 200 is in the open position 116, elongate channel 228 extends bridges across between inlet opening 210 and outlet opening 216 providing a flow passage between inlet 102 and outlet 106 fluidly coupling inlet 102 and outlet 106. Valve 200 is moved to the open position 116 (FIG. 1) by rotating fluid flow selector plate 206 counter-clockwise and when valve 200 is in the open position 114, elongate channel 228 extends between inlet opening 212 and outlet opening 214 providing a flow passage between inlet 104 and outlet 108 fluidly coupling inlet 104 to outlet 108.

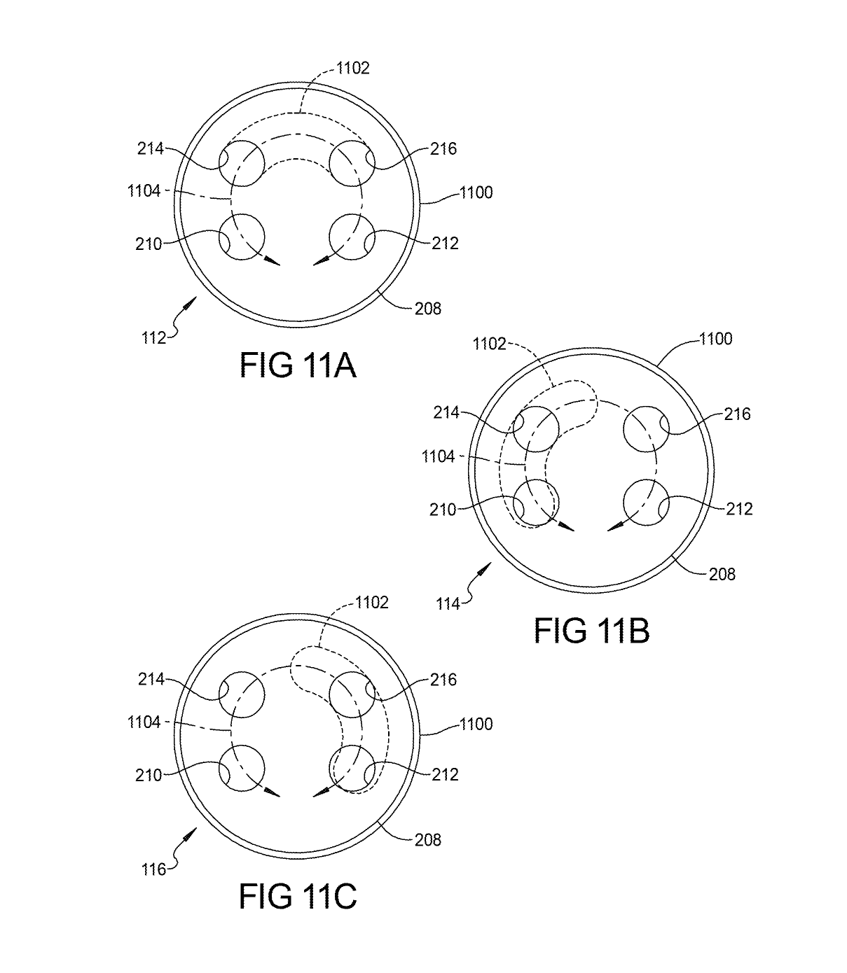

FIGS. 11A-11C show a fluid flow selector plate 1100 that is a variation of fluid flow selector plate 206 and in a variation, valve 200 has fluid flow selector plate 1100 instead of fluid flow selector plate 206. In FIGS. 11A-11C, fluid flow selector plate 1100 is coaxial with and behind inlet/outlet plate 208. Fluid flow selector plate 1100 has an offset arcuate channel 1102 that provides the fluid passage. Offset arcuate channel 1102 is offset from a center of fluid flow selector plate 1100 and offset arcuate channel 1102 lies in an arc 1104 (FIG. 11A) in which inlet openings 210, 212 and outlet openings 214, 216 also lie. Fluid flow selector plate is rotatable with respect to inlet/outlet plate 208 among closed position 112 shown in FIG. 11A, open position 114 shown in FIG. 11B and open position 116 shown in FIG. 11C. When in closed position 112 shown in FIG. 11A, arcuate channel 1102 does not bridge across any of inlet openings 210, 212 to any of outlet openings 214, 216. In this closed position, offset arcuate channel 1102 does bridge across outlet opening 214 to outlet opening 216 to provide a vent path.

In operation, valve 200 having fluid flow selector plate 1100 is moved to the open position 114 (FIG. 11B) by rotating fluid flow selector plate 1100 counter-clockwise. When valve 200 having fluid flow selector plate 1100 is in open position 114, offset arcuate channel 1102 bridges across inlet opening 210 to outlet opening 214 allowing fluid to flow from inlet opening 210 to outlet opening 214 but not from inlet opening 212 to outlet opening 216. Valve 200 having fluid flow selector plate 1100 is moved to the open position 116 (FIG. 11B) by rotating fluid flow selector plate 1100 clockwise. When valve 200 having fluid flow selector plate 1100 is in open position 116, offset arcuate channel 1102 bridges across inlet opening 212 to outlet opening 216 allowing fluid to flow from inlet opening 212 to outlet opening 216 but not from inlet opening 210 to outlet opening 214.

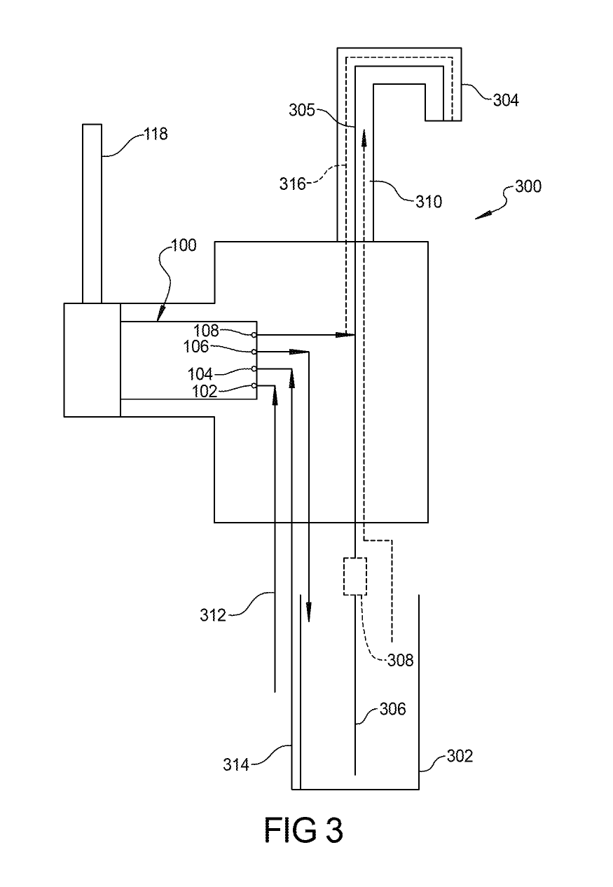

FIG. 3 is a diagrammatic view of a conditioned water dispenser 300 having valve 100. It should be understood that valve 100 can be valve 200 having fluid flow selector plate 206 as shown in FIG. 2 or having the fluid flow selector plate 1100 as shown in FIGS. 11A-11C. A supply line 312 is fluidly coupled to inlet 102 of valve 100 and a supply line 314 is fluidly coupled to inlet 104 of valve 100. Outlet 106 of valve 100 is fluidly coupled to water source 302 and outlet 108 of valve 100 is fluidly coupled to an outlet line 305 of a faucet spout 304. An outlet 306 of the water source is also fluidly coupled to the outlet line 305 of faucet spout 304. Conditioned water dispenser 300 can be any type of conditioned water dispenser including hot water, chilled water, filtered water, distilled water, deionized water, reverse osmosis water, carbonated water, or other types of conditioned water. In an aspect, outlet 108 is fluidly coupled to a separate outlet line 316 of faucet spout 304 instead of outline line 305.

In an aspect, conditioned water dispenser 300 is a hot water dispenser and water source 302 is a heated tank. Conditioned water dispenser 300 then includes a check valve 308 through which outlet 306 is fluidly coupled to outlet line 305 of faucet spout 304. Faucet spout 304 optionally then also has a vent path 310 that extends into the tank that is water source 302.

In an aspect, outlet 108 is alternatively fluidly coupled to an outlet line 316 of faucet spout 304 instead of outlet line 305.

With reference to conditioned water dispenser 300 being a hot water dispenser, in operation, when valve 100 is in open position 114 (FIG. 1), water flows from supply line 312 into inlet 102, from inlet 102 to outlet 106, and from outlet 106 into water source 302 forcing hot water from water source out through outlet 306 into outlet line 305 of faucet spout 304. When valve 100 is in open position 116 (FIG. 1), water flows from supply line 314 into inlet 104, from inlet 104 to outlet 108, and from outlet 108 into outlet line 305 of faucet spout 304.

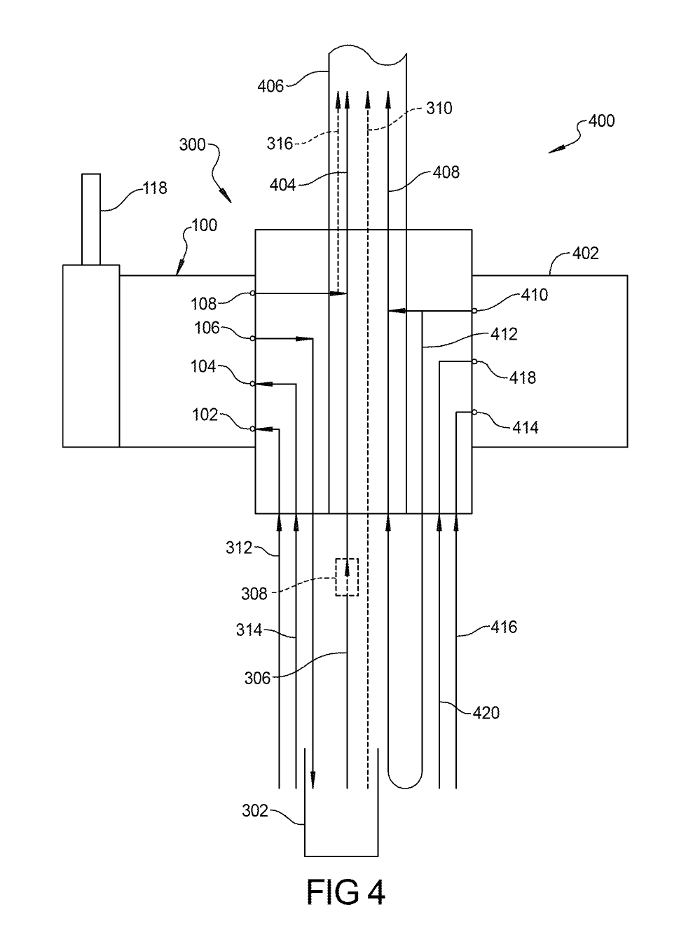

FIG. 4 is a diagrammatic view of a water dispenser 400 having conditioned water dispenser 300, which has valve 100, and also having a hot/cold water mixing valve 402. It should be understood that valve 100 can be valve 200 having fluid flow selector plate 206 as shown in FIG. 2 or having the fluid flow selector plate 1100 as shown in FIGS. 11A-11C. The arrangement of conditioned water dispenser 300 in water dispenser 400 is essentially the same as shown in FIG. 3 with an outlet line 404 of a faucet spout 406 fluidly coupled to outlet 108 of valve 100 of conditioned water dispenser 300 and also to outlet 306 of conditioned water dispenser 300. Faucet spout 406 also has a mixed water outlet line 408 fluidly coupled to an outlet 410 of hot/cold water mixing valve 402. Water dispenser 400 can optionally include a sprayer (not shown) in which case a mixed water sprayer outlet line 412 is also fluidly coupled to outlet 410 of hot/cold water mixing valve 402. An inlet 414 of hot/cold water mixing valve 402 is fluidly coupled to a hot water supply line 416 and an inlet 418 is fluidly coupled to a cold water supply line 420.

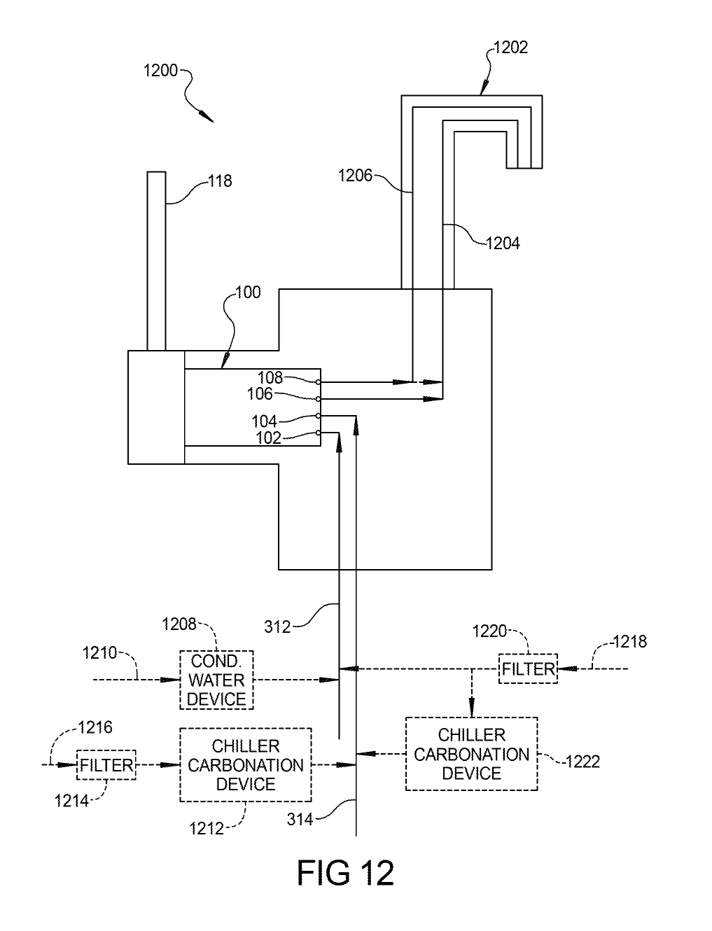

FIG. 12 is a diagrammatic view of water dispenser 1200 having valve 100 and a faucet spout 1202. It should be understood that valve 100 can be valve 200 having fluid flow selector plate 206 as shown in FIG. 2 or having the fluid flow selector plate 1100 as shown in FIGS. 11A-11C. Supply line 312 is fluidly coupled to inlet 102 of valve 100 and supply line 314 is fluidly coupled to inlet 104 of valve 100. Outlet 106 of valve 100 is fluidly coupled to a first outlet line 1204 of faucet spout 1202 and outlet 108 of valve 100 is fluidly coupled to a second outlet line 1206 of a faucet spout 1202. In an aspect, outlet 108 is fluidly coupled to first outlet line 1204 instead of second outlet line 1206 and second outlet line 106 can then be dispensed with.

In an aspect, supply line 312 is illustratively a hot tap water supply line and supply line 314 is illustratively a cold tap water supply line and water dispenser 1300 is thus a faucet.

In an aspect, supply line 312 is fluidly coupled to a conditioned water device 1208 of conditioned water shown in phantom in FIG. 12 that is fluidly coupled to a water supply line 1210 shown in phantom in FIG. 12. In an aspect, supply line 314 is fluidly coupled to a chiller/carbonation device 1212 shown in phantom in FIG. 12 to which a water supply line 1216 shown in phantom in FIG. 12 is fluidly coupled through a filter 1214 shown in phantom in FIG. 12.

In an aspect, a water supply line 1218 shown in phantom in FIG. 12 is fluidly coupled through a filter 1220 shown in phantom in FIG. 12 to supply line 312 and through filter 1220 to a chiller/carbonation device 1222 shown in phantom in FIG. 12 that in turn is fluidly coupled to supply line 314.

It should be understood that conditioned water device 1208 could be any of a filtered water device, a chiller/carbonation device, a pressurized hot water (boiling) tank, or a device that provides other types of pressurized fluids such as juice, tea, coffee and the like.

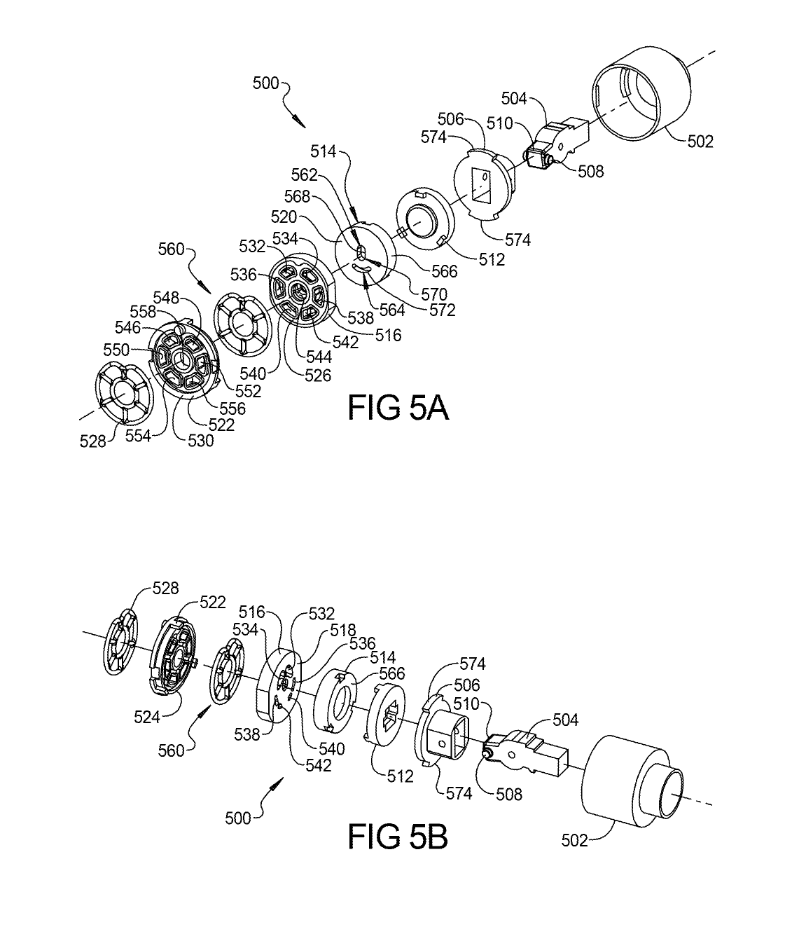

FIG. 5A is an exploded view of a fluid valve 500 having four inlets and three outlets in accordance with an aspect of the present disclosure and FIG. 5B is an exploded view of valve 500 from a different orientation. Valve 500 includes a valve housing 502 having a spindle 504, a spindle carrier 506 in which opposed pins 508 (only one of which is shown in FIGS. 5A and 5B) extending transversely from an end 510 of spindle 504 are received, a spindle adapter 512 in which end 510 of spindle 504 is received, a fluid flow selector 514 engaged with spindle adapter 512, an inlet/outlet plate 516 having an inner surface 518 (FIG. 5B) abutting an outer surface 520 (FIG. 5A) of fluid flow selector 514 and a surface plate 522 having an inner surface 524 (FIG. 5B) abutting an outer surface 526 (FIG. 5A) of inlet/outlet plate 516. A gasket 528 is received on an outer face 530 of surface plate 522. Inlet outlet/plate 516 has four inlet openings, inlet openings 532, 534, 536 and 538, and three outlet openings, outlet openings 540, 542 and mixed-flow outlet opening 544. Surface plate 522 has inlet openings 546, 548, 550, 552 (FIG. 5A) corresponding to inlet openings 532, 534, 536, 538 of inlet/outlet plate 516 and outlet openings 554, 556, 558 (FIG. 5A) corresponding to outlet openings 540, 542, 544 of inlet/outlet plate 516. A gasket 560 is disposed between inlet/outlet plate 516 and surface plate 522 and configured to seal around the respective openings in the inlet/outlet plate 516 and surface plate 522.

Fluid flow selector 514 includes fluid passage 562 and fluid passage 564. In the example embodiment of FIGS. 5A & 5B and with reference to FIG. 5A, fluid flow selector 514 is a fluid flow selector plate 566 and fluid passage 562 is an elongate central channel 568 in fluid flow selector plate 566 at a central portion 570 thereof and fluid passage 564 is an offset arcuate channel 572 in fluid flow selector plate 566 offset from central portion 570. In the example of FIGS. 5A and 5B and as oriented in FIGS. 5A and 5B, offset arcuate channel 572 which forms fluid passage 564 is disposed below elongate central channel 568 which forms fluid passage 562.

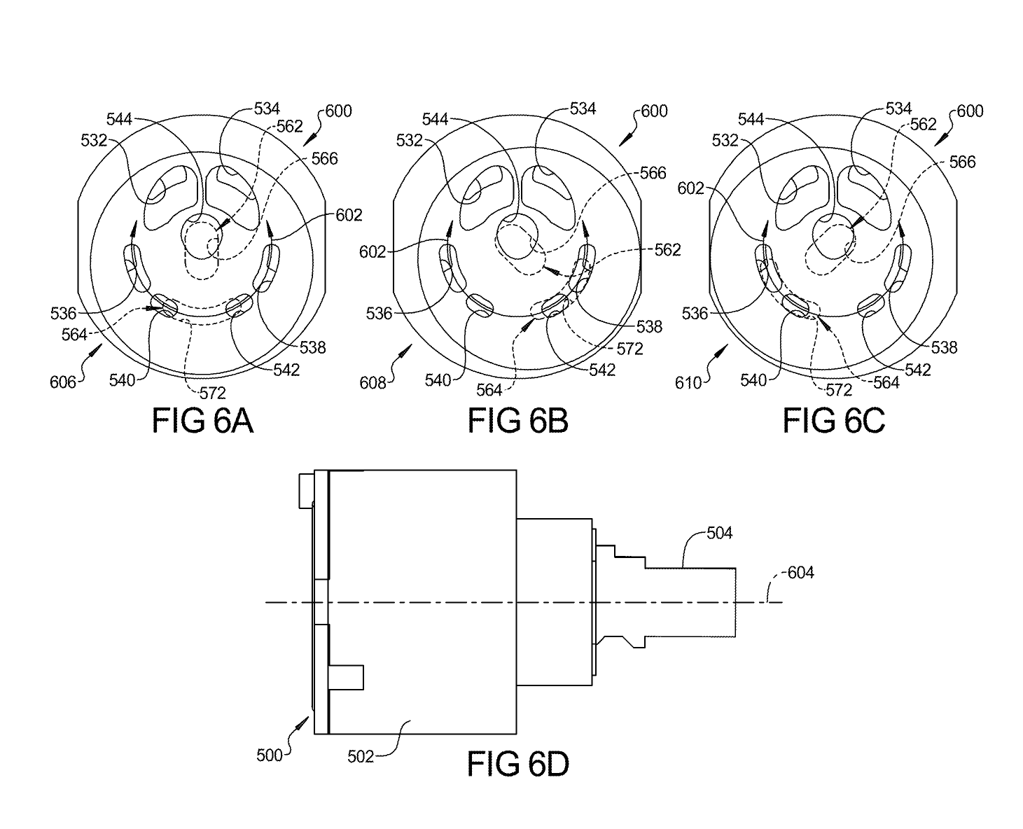

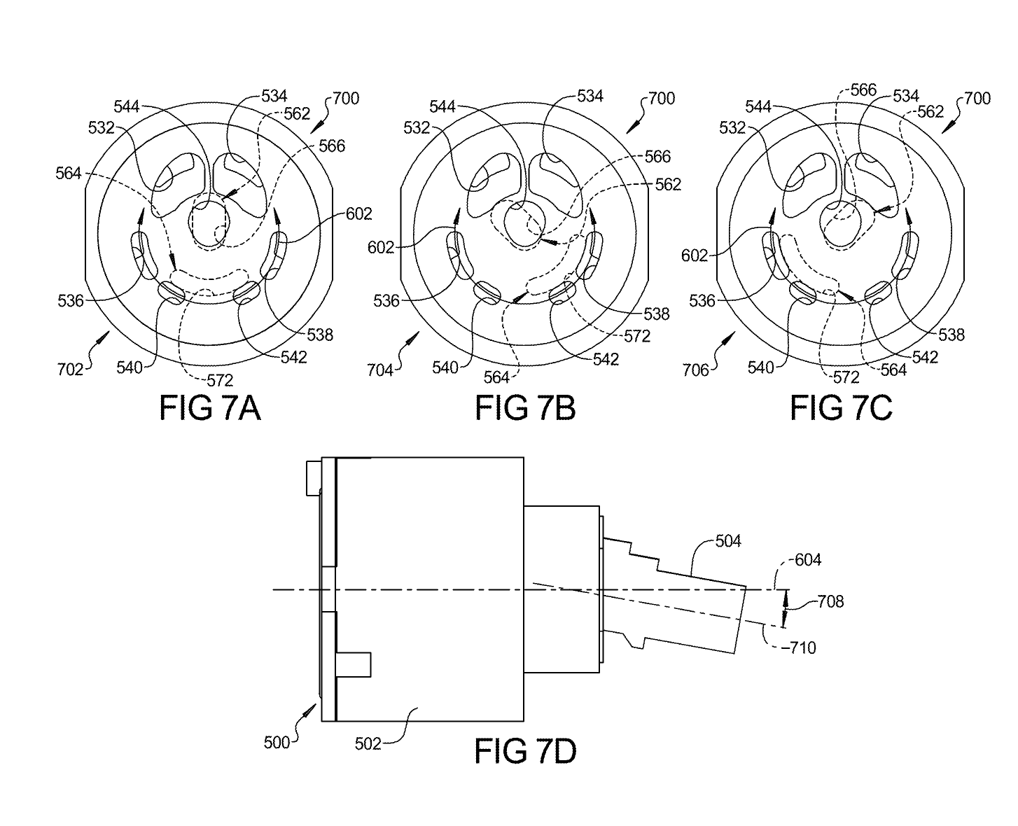

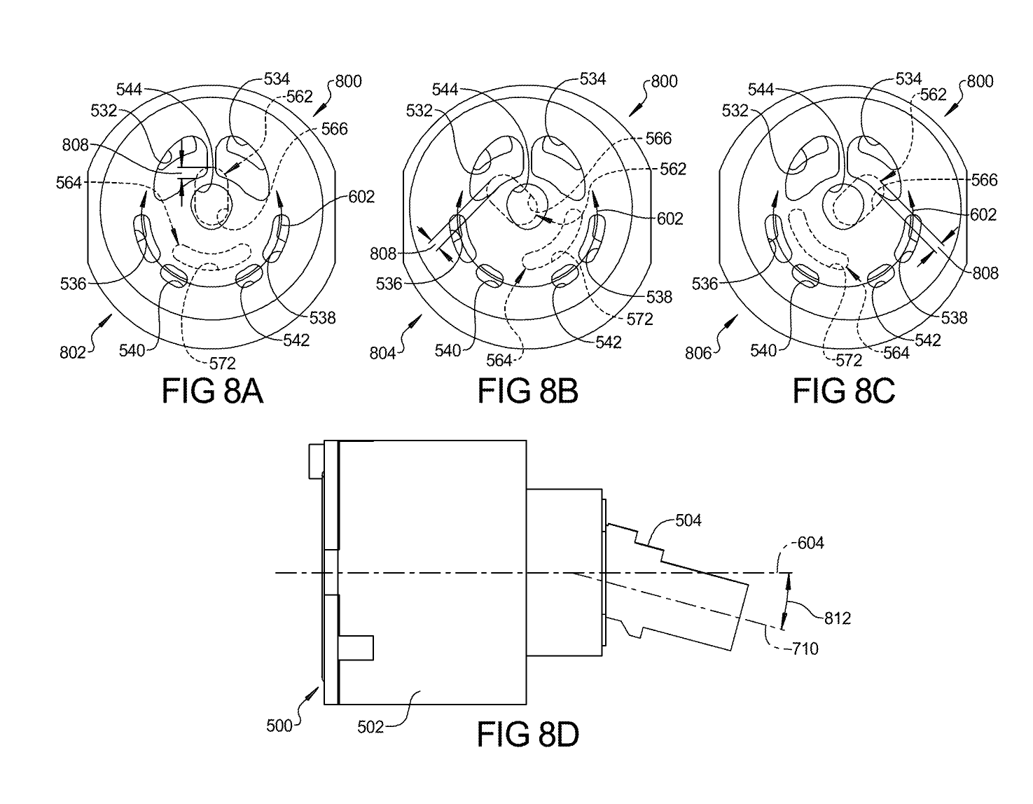

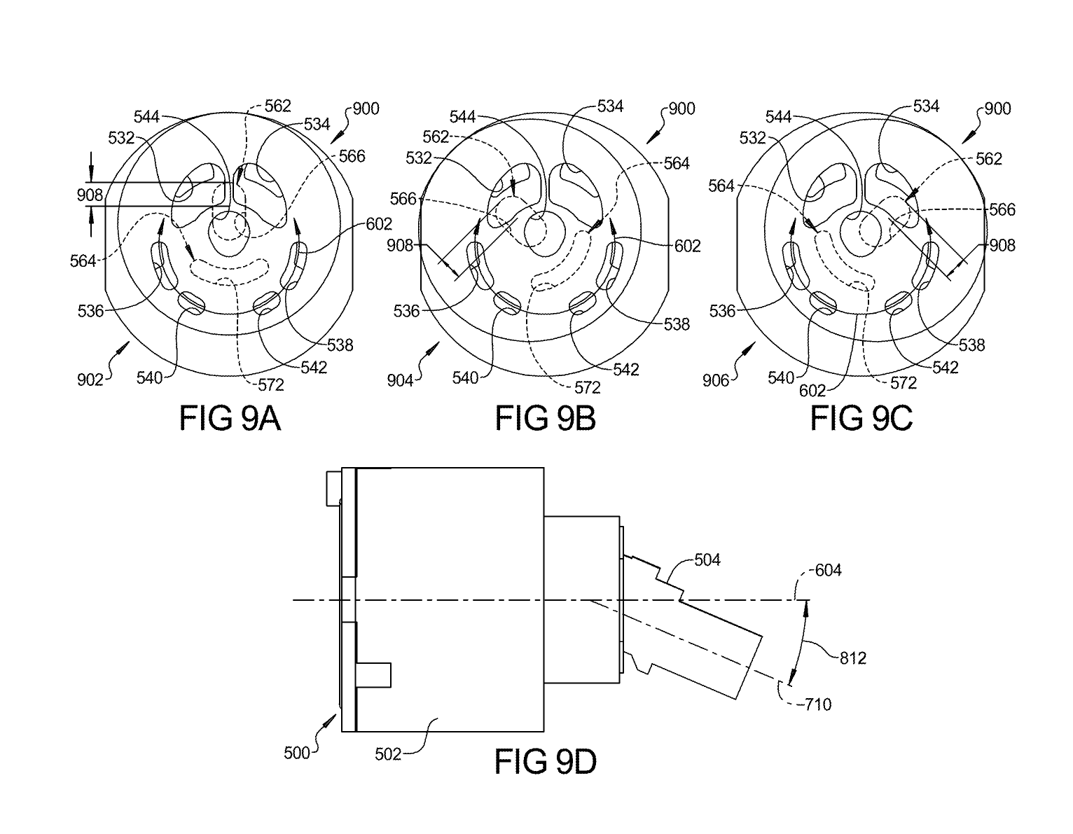

As explained in more detail below, fluid flow selector 514 is rotatable with respect to inlet/outlet plate 516 and also movable radially with respect to inlet/outlet plate 516 to selectively fluidly couple inlet openings 532, 534 to mixed-flow outlet opening 544, selectively fluidly couple inlet opening 536 to outlet opening 540 and selectively fluidly couple inlet opening 538 to outlet opening 542. In this regard, spindle 504 is coupled by spindle carrier 506 and spindle adapter 512 to fluid flow selector 514. Spindle 504 is rotated by a user to rotate fluid flow selector 514 with respect to inlet/outlet plate 516 and moved back and forth (up and down as oriented in FIG. 5) to move fluid flow selector 514 radially with respect to inlet/outlet plate 516. Wings 574 of spindle carrier 506 limit rotation. Movement of spindle 504 back and forth (up and down as oriented in FIG. 5) moves spindle adapter 512 radially back and forth which in turn moves fluid flow selector 514 radially with respect to inlet/outlet plate 516. Fluid flow selector 514 is movable radially with respect to inlet/outlet plate 516 among an auxiliary flow position 600, shown in FIGS. 6A-6C, a neutral flow position 700, shown in FIGS. 7A-7C, a mixed flow-low volume position 800, shown in FIGS. 8A-8C, and a mixed flow-full volume position 900, shown in FIGS. 9A-9C. In each of these positions, fluid flow selector 514 is rotatable with respect to inlet/outlet plate 516 to provide various fluid flows from the inlets of inlet/outlet plate 516 to the outlets of inlet/outlet plate 516 as discussed below.

In the example embodiment where fluid passage 564 is offset arcuate channel 572, when fluid flow selector 514 is in auxiliary flow position 600 shown in FIGS. 6A-6C, fluid flow selector 514 is radially offset with respect to inlet/outlet plate 516 with offset arcuate channel 572 in a same arc 602 as inlet openings 536, 538 and outlet openings 540, 542 and spindle 504 is at a zero degree angle with respect to a longitudinal axis 604 of valve 500 as shown in FIG. 6D.

When fluid flow selector 514 is in auxiliary flow position 600, it can be rotated with respect inlet/outlet plate 516 among an auxiliary flow off position 606 shown in FIG. 6A, a first auxiliary flow on position 608 shown in FIG. 6B and a second auxiliary flow on position 610 shown in FIG. 6C. In each of these auxiliary flow positions, fluid passage 562 does not fluidly couple either of inlet openings 532, 534 to mixed-flow outlet opening 544 and there is thus no fluid flow from either of inlet openings 532, 534 to mixed-flow outlet opening 544. More specifically in the embodiment where fluid flow selector 514 is fluid flow selector plate 566 and fluid passage 562 is elongate central channel 568, elongate central channel 568 does not bridge across either of inlet openings 532, 534 to mixed-flow outlet opening 544 when fluid flow selector plate 566 is in the auxiliary flow position 600.

When fluid flow selector 514 is in auxiliary flow off position 606 shown in FIG. 6A, fluid passage 562 does not fluidly couple inlet opening 536 to outlet opening 540 or inlet opening 538 to outlet opening 542 and there is thus no fluid flow from inlet opening 536 to outlet opening 540 or from inlet opening 538 to outlet opening 542. More specifically in the embodiment where fluid flow selector 514 is fluid flow selector plate 566 and fluid passage 564 is offset arcuate channel 572, offset arcuate channel 572 does not bridge across inlet opening 536 to outlet opening 540 or across inlet opening 538 to outlet opening 542 when fluid flow selector plate 566 is in the auxiliary flow off position 606.

In an aspect, when fluid flow selector 514 is in auxiliary flow off position 606, fluid passage 564 fluidly couples outlet opening 540 to outlet opening 542. More specifically in the embodiment where fluid flow selector 514 is fluid flow selector plate 566 and fluid passage 564 is offset arcuate channel 572, offset arcuate channel 572 bridges across outlet opening 540 to outlet opening 542. This aspect is advantageously used in hot water dispensing systems having a non-pressurized tank to provide a vent path when fluid flow selector 514 is in auxiliary flow off position 606.

When fluid flow selector 514 is in first auxiliary flow on position 608 shown in FIG. 6B, fluid passage 564 fluidly couples inlet opening 538 to outlet opening 542 but not inlet opening 536 to outlet opening 540 allowing fluid to flow from inlet opening 538 to outlet opening 542 but not from inlet opening 536 to outlet opening 540. More specifically in the embodiment where fluid flow selector 514 is fluid flow selector plate 566 and fluid passage 564 is offset arcuate channel 572, offset arcuate channel 572 bridges across inlet opening 538 to outlet opening 542 but not across inlet opening 536 to outlet opening 540 when fluid flow selector plate 566 is in first auxiliary flow on position 608.

When fluid flow selector 514 is in second auxiliary flow on position 610 shown in FIG. 6C, fluid passage 564 fluidly couples inlet opening 536 to outlet opening 540 but not inlet opening 538 to outlet opening 542 allowing fluid to flow from inlet opening 536 to outlet opening 540 but not from inlet opening 538 to outlet opening 542. More specifically in the embodiment where fluid flow selector 514 is fluid flow selector plate 566 and fluid passage 564 is offset arcuate channel 572, offset arcuate channel 572 bridges across inlet opening 536 to outlet opening 540 but not across inlet opening 538 to outlet opening 542 when fluid flow selector plate 566 is in second auxiliary flow on position 610.

With reference to FIGS. 7A-7C, when fluid flow selector 514 is in neutral flow position 700, fluid passage 562 does not couple either of inlet openings 532, 534 to mixed-flow outlet opening 544 regardless of the rotational position of fluid flow selector 514 with respect to inlet/outlet plate 516 as shown by positions 702 (FIG. 7A), 704 (FIG. 7B) and 706 (FIG. 7C) which correspond to rotational positions 606, 608, 610 of fluid flow selector 514 with respect to inlet/outlet plate 516 shown in FIGS. 6A-6C. Also, fluid passage 564 does not couple inlet opening 536 to outlet opening 540 or inlet opening 538 to outlet opening 542 regardless of the rotational position of fluid flow selector 514 with respect to inlet/outlet plate 516.

In the example embodiment where fluid flow selector 514 is fluid flow selector plate 566 and fluid passage 562 is an elongate central channel 568 and fluid passage 564 is offset arcuate channel 572, when fluid flow selector plate 566 is in neutral flow position 700 shown in FIGS. 7A-7C, fluid flow selector plate 566 is radially centered with respect to inlet/outlet plate 516 with offset arcuate channel 572 in a different arc as arc 602 in which inlet openings 536, 538 and outlet openings 540, 542 lie so that no portion of offset arcuate channel 572 overlaps arc 602. Also, no portion of elongate central channel 568 will overlap inlet openings 532, 534 regardless of the rotational position of fluid flow selector 514 with respect to inlet/outlet plate 516. Further, spindle 504 is at an angle 708 with respect to a longitudinal axis 604 of valve 500 as shown in FIG. 7D with angle 708 shown between a centerline 710 of spindle 504 and longitudinal axis 604 of valve 500.

With reference to FIGS. 8A-8C, when fluid flow selector 514 is in mixed flow-low volume position 800, fluid passage 564 does not couple inlet opening 536 to outlet opening 540 or inlet opening 538 to outlet opening 542 regardless of the rotational position of fluid flow selector 514 with respect to inlet/outlet plate 516. When fluid flow selector 514 is in mixed flow-low volume position 800, it can be rotated with respect to inlet/out plate 516 among a mixed flow-low volume on position 802 shown in FIG. 8A, a first flow-low volume on position 804 shown in FIG. 8B and a second flow-low volume on position 806 shown in FIG. 8C. It should be understood that position 800 is referred to as a mixed flow-low volume position because when fluid flow selector 514 is in this position, its rotational positions include mixed flow-low volume on position 802 that allows fluid to flow from both of inlet openings 532, 534 to mixed-flow outlet opening 544 thus providing a flow of mixed fluid at mixed-flow outlet opening 544 even though a flow of mixed fluid is not provided at mixed-flow outlet opening 544 when fluid flow selector 514 is either its first flow-low volume on position 804 or its second flow-low volume on position 806.

When fluid flow selector 514 is in mixed flow-low volume on position 802 shown in FIG. 8A, fluid passage 562 fluidly couples inlet openings 532, 534 to mixed-flow outlet opening 544 allowing fluid to flow from both inlet openings 532, 534 to mixed-flow outlet opening 544. When fluid flow selector 514 is in first flow-low volume on position 804 shown in FIG. 8B, fluid passage 562 fluidly couples inlet opening 532 to mixed-flow outlet opening 544 but not inlet opening 534 to mixed-flow outlet opening 544 allowing fluid to flow only from inlet opening 532 to mixed-flow outlet opening 544 but not from inlet opening 534 to mixed-flow outlet opening 544. When fluid flow selector 514 is in second flow-low volume on position 804 shown in FIG. 8B, fluid passage 562 fluidly couples inlet opening 534 to mixed-flow outlet opening 544 but not inlet opening 532 to mixed-flow outlet opening 544 allowing fluid to flow only from inlet opening 534 to mixed-flow outlet opening 544 but not from inlet opening 532 to mixed-flow outlet opening 544. In an aspect, only a small portion of fluid passage 562 opens to either or both inlet openings 532, 532 (depending on which of the above mixed flow-low volume positions fluid flow selector 514 is in) so that the volume of fluid that can flow from any of inlet openings 532, 544 to mixed-flow outlet opening 544 is low. More specifically in the embodiment where fluid flow selector 514 is fluid flow selector plate 566 and flow passage 562 is elongate central channel 568, a first section 808 of end portion 810 of elongate central channel 568 that opens to either or both of inlet openings 532, 534 (depending on which of the above mixed flow-low volume positions fluid flow selector 514 is in) has an area that is sized so that it allows only a low volume of fluid to flow from any of the inlet openings 532, 534 to mixed-flow outlet opening 544.

In the example embodiment where fluid flow selector 514 is fluid flow selector plate 566 and fluid passage 562 is elongate central channel 568 and fluid passage 564 is offset arcuate channel 572, when fluid flow selector plate 566 is in mixed flow-low volume position 800 shown in FIGS. 8A-8C, fluid flow selector plate 566 is radially offset with respect to inlet/outlet plate 516 toward inlet openings 532, 534 with offset arcuate channel 572 in a different arc than arc 602 in which openings 536, 538 and outlet openings 540, 542 lie so that no portion of offset arcuate channel 572 overlaps arc 602. Further, spindle 504 is at an angle 812 with respect to a longitudinal axis 604 of valve 500 as shown in FIG. 8D.

With reference to FIGS. 9A-9C, fluid passage 564 does not couple inlet opening 536 to outlet opening 540 or inlet opening 538 to outlet opening 542 regardless of the rotational position of fluid flow selector 514 with respect to inlet/outlet plate 516. When fluid flow selector 514 is in mixed flow-high volume position 900, it can be rotated with respect to inlet/outlet plate 516 among a mixed fluid flow-high volume on position 902 shown in FIG. 9A, a first fluid flow-high volume on position 904 shown in FIG. 9B and a second fluid flow-high volume on position 906 shown in FIG. 9C. It should be understood that position 900 is referred to as a mixed flow-high volume position because when fluid flow selector 514 is in this position, its rotational positions include mixed-flow high volume on position 902 that allows fluid to flow from both of inlet openings 532, 534 to mixed-flow outlet opening 544 thus providing a flow of mixed fluid at outlet opening 532 even though a flow of mixed fluid is not provided at mixed-flow outlet opening 544 when fluid flow selector 514 is either its first flow-high volume on position 904 or its second flow-high volume on position 906.

When fluid flow selector 514 is in mixed flow-high volume on position 902 shown in FIG. 9A, fluid passage 562 fluidly couples inlet openings 532, 534 to mixed-flow outlet opening 544 allowing fluid to flow from both inlet openings 532, 534 to mixed-flow outlet opening 544. When fluid flow selector 514 is in first flow-high volume on position 904 shown in FIG. 9B, fluid passage 562 fluidly couples inlet opening 532 to mixed-flow outlet opening 544 but not inlet opening 534 to mixed-flow outlet opening 544 allowing fluid to flow only from inlet opening 532 to mixed-flow outlet opening 544 but not from inlet opening 534 to mixed-flow outlet opening 544. When fluid flow selector 514 is in second flow-high volume on position 904 shown in FIG. 9B, fluid passage 562 fluidly couples inlet opening 534 to mixed-flow outlet opening 544 but not inlet opening 532 to mixed-flow outlet opening 544 allowing fluid to flow only from inlet opening 534 to mixed-flow outlet opening 544 but not from inlet opening 532 to mixed-flow outlet opening 544. In an aspect, a portion of fluid passage 562 that opens to either or both inlet openings 532, 532 (depending on which of the above mixed flow-low volume positions fluid flow selector 514 is in) is larger than when fluid flow selector 514 is in the mixed flow low-volume position 800 so that the volume of fluid that can flow from any of inlet openings 532, 544 to mixed-flow outlet opening 544 is high. More specifically when fluid flow selector 514 is fluid flow selector plate 566 and fluid flow passage 562 is elongate central channel 568, a second section 908 of fluid passage 562 that opens to either or both inlet openings 532, 534 (depending on which of the above mixed flow-low volume positions fluid flow selector 514 is in) is sized so that the volume of fluid that can flow from any of inlet openings 532, 534 to mixed-flow outlet opening 544 is high. In this regard, it should be understood that second section 908 of fluid passage 562 includes first section 808 of fluid passage 562 and second section 908 is larger than first section 808.

In the example embodiment where fluid flow selector 514 is fluid flow selector plate 566 and fluid passage 562 is an elongate central channel 568 and fluid passage 564 is offset arcuate channel 572, when fluid flow selector plate 566 is in mixed-flow high volume position 900 shown in FIGS. 9A-9C, fluid flow selector 514 is radially offset with respect to inlet/outlet plate 516 toward inlet openings 532, 534 with offset arcuate channel 572 in a different arc than arc 602 in which inlet openings 536, 538 and outlet openings 540, 542 lie so that no portion of offset arcuate channel 572 overlaps arc 602. Further, spindle 504 is at an angle 910 with respect to a longitudinal axis 604 of valve 500 as shown in FIG. 9D.

In an aspect, fluid flow selector 514 is also positionable anywhere between mixed flow low-volume position 800 and mixed flow high-volume position 900 to adjust the volume of fluid flow that flows from either or both inlet openings 532, 534 (depending on the rotational position that fluid flow selector 514 is in) to mixed-flow outlet opening 544.

It should be understood that the terms low volume and high volume as used herein are relative terms with respect to each other. That is, low volume means that the volume of fluid flow is lower than the volume of fluid flow at high volume.

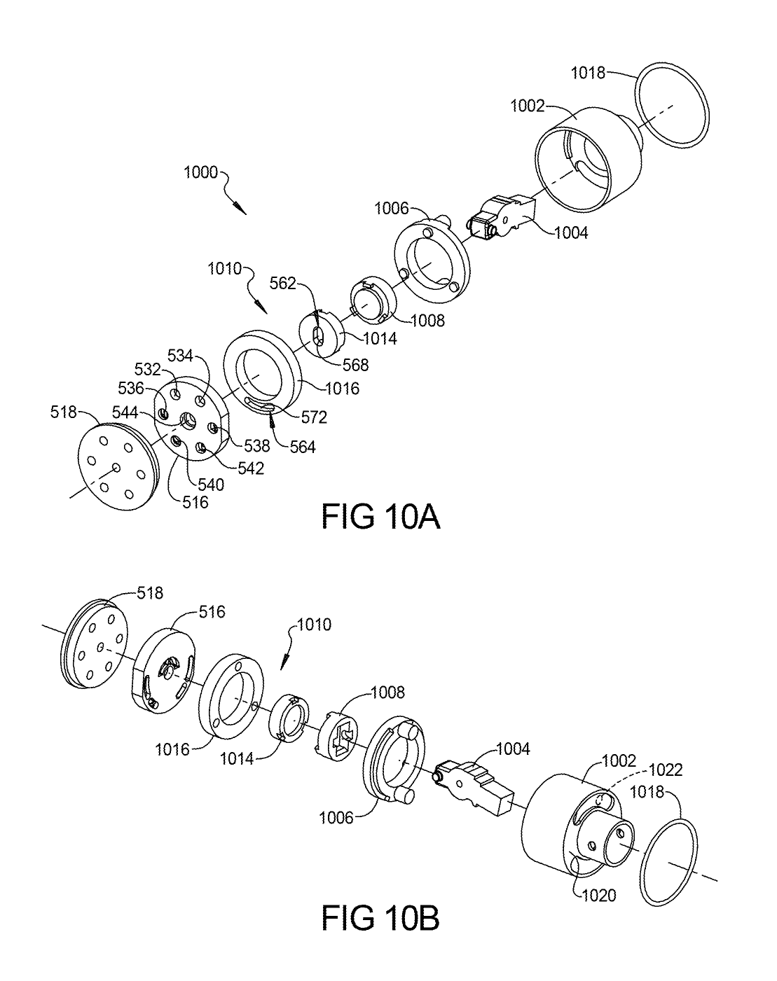

FIG. 10A is an exploded view of a fluid valve 1000 having four inlets and three outlets in accordance with an aspect of the present disclosure that is a variation of valve 500 and FIG. 10B is an exploded view of valve 1000 from a different orientation. The discussion of valve 1000 will thus focus on the differences.

Valve 1000 includes a valve housing 1002, a spindle 1004, a handle adapter 1006, a spindle adapter 1008, fluid flow selector 1010, inlet/outlet plate 516 and surface plate 522. Fluid flow selector 1010 illustratively includes fluid flow selector concentric disks 1014, 1016 with flow selector disk 1014 an inner concentric disk and referred to herein as inner concentric flow selector disk 1014 and fluid flow selector disk 1016 an outer concentric disk and referred to herein as outer concentric flow selector disk 1016. Inner flow selector disk 1014 is movable radially and rotationally within outer concentric flow selector disk 1016 and thus also with respect to inlet/outlet plate 516. Outer concentric flow selector disk 1016 is movable rotationally with respect to inlet/outlet plate 516.

Spindle 1004 is coupled via spindle adapter 1008 to inner concentric flow selector disk 1014 and spindle 1004 is moved back and forth to move inner concentric flow selector disk 1014 radially with respect to inlet/outlet plate 516 and rotated to rotate inner concentric flow selector disk 1014 with respect to inlet/outlet plate 516. A handle 1018, illustratively a ring, disposed at an outer face 1024 of valve housing 1002 is coupled via handle adapter 1006 to outer concentric flow selector disk 1016 and handle 1018 is rotated to rotate outer concentric flow selector disk 1016 with respect to inlet/outlet plate 516.

Inner concentric flow selector disk 1014 includes fluid passage 562 which is illustratively elongated central channel 568. Inner concentric flow selector disk 1014 is movable radially and rotationally with respect to inlet/outlet plate 516 to mixed flow positions comparable to those described above with respect to flow valve 500. That is, inner concentric flow selector disk 1014 is positionable with respect to inlet/outlet plate 516 to position fluid passage 562 to fluidly couple either or both inlet openings 532, 534 to mixed-flow outlet opening 544 at various volume flows (depending on the radial position of inner concentric flow disk 1018 as well to a position where flow passage 562 does not fluidly couple either of inlet openings 532, 534 to mixed-flow outlet opening 544.

Outer concentric flow selector disk 1016 includes fluid passage 564 which is illustratively offset arcuate channel 572. Outer concentric flow selector disk 1016 is rotatable with respect to inlet/outlet plate 516 to auxiliary flow positions comparable to those described above with respect to flow valve 500. That is, outer concentric flow selector disk 1016 is rotatable with respect to inlet/outlet plate 516 to position fluid passage 562 to fluidly couple inlet opening 532 to outlet opening 540, fluidly couple inlet opening 534 to outlet opening 542, or where fluid passage 564 does not fluidly couple inlet opening 532 to outlet opening 540 or inlet opening 536 to outlet opening 542. In an aspect, when fluid passage 564 is in the position where it does not fluidly couple inlet opening 532 to outlet opening 540 or inlet opening 538 to outlet opening 542, fluid passage 564 fluidly couples outlet opening 540 to outlet opening 542 to provide a vent path.

In valve 1000, movement of inner concentric flow selector disk 1014 is independent of movement of outer concentric flow selector disk 1016. Spindle 1004 is moved by a user to select the desired mixed flow position and handle 1018 moved by the user to select the desired auxiliary flow position.

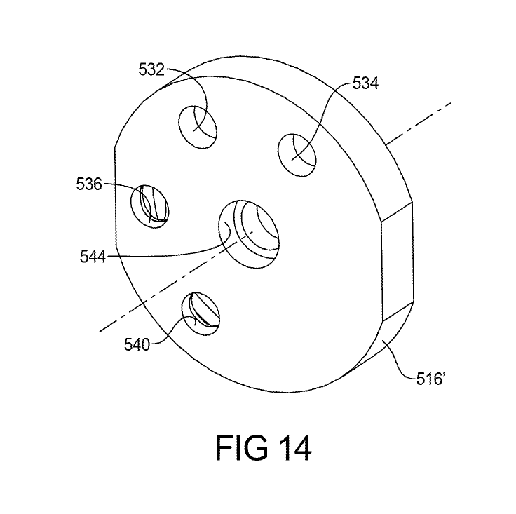

FIG. 14 shows an inlet/outlet plate 516′ that is a variation of inlet/outlet plate 516. Inlet/outlet plate 516′ does not have inlet opening 538 or outlet opening 542. Replacing inlet/outlet plate 516 in fluid valve 500 or fluid valve 1000 changes these fluid valves from four inlet/three outlet valves to three inlet/two outlet valves and this variation only has one auxiliary flow on position instead of two. In an aspect a faucet having this variation is configured to limit the rotation of the handle so that when the applicable fluid flow selector is in the auxiliary flow position, it can only be rotated between one auxiliary flow on position and the auxiliary flow off position. In an aspect of fluid valve 1000 having inlet/outlet plate 516′, a valve housing 1002 has a stop 1022 shown in phantom in FIG. 10B that limits the rotation of outer concentric disk 1016 so that it can only be rotated between one auxiliary flow on position and the auxiliary flow off position.

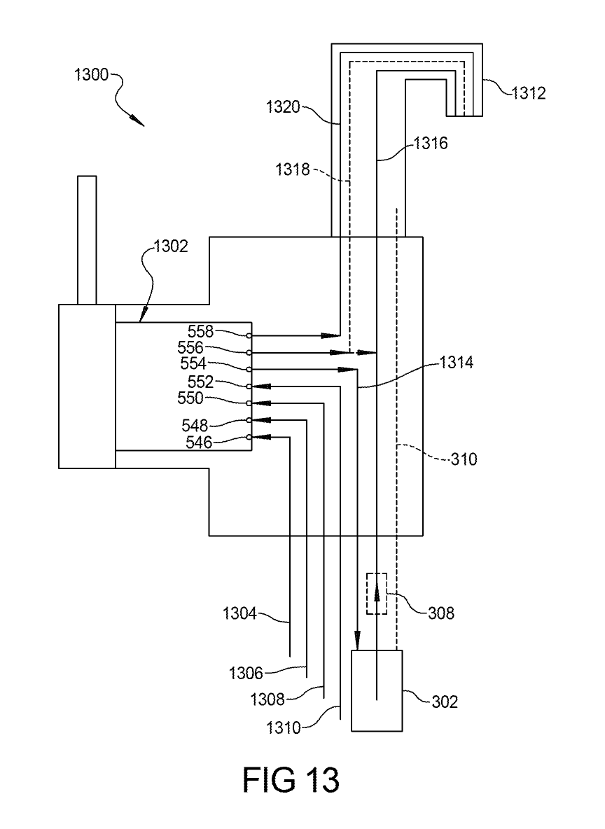

Fluid valves 500, 1000 can for example be used for a water dispenser of the type described above with reference to conditioned water dispenser 300, water dispenser 400 and water dispenser 1200. FIG. 13 is a diagrammatic view of a water dispenser 1300 having a fluid valve 1302 that can be either of fluid valve 500 or fluid valve 1000. With the exception of having valve 1302 instead of valve 100, water dispenser 1300 is otherwise the same as conditioned water dispenser 400. Inlet openings 546, 548 of surface plate 522 are fluidly coupled to hot and cold tap water supply lines 1304, 1306, respectively, and mixed-flow outlet opening 558 of surface plate 522 is fluidly to a mixed flow outlet line 1320 of a faucet spout 1312. Inlet opening 550 of surface plate 522 is fluidly coupled to auxiliary supply line 1308 (which is a supply line for a first type of auxiliary water) and outlet opening 554 of surface plate 522 is fluidly coupled to an inlet of water source 302 of water dispenser 1300. An outlet of water source 302 is fluidly coupled to outlet line 1316 of faucet spout 1312. Outlet opening 556 of surface plate 522 is also fluidly coupled to outlet line 1316 or, alternatively, to outlet line 1318 of faucet spout 1312 as shown in phantom in FIG. 13. If water dispenser 1300 is a hot water dispenser, it also includes check valve 308 and vent path 310 as shown in phantom in FIG. 13.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A multi-flow valve, comprising:
a valve housing in which a spindle, a fluid flow selector and an inlet/outlet plate are received and a surface plate affixed to a proximal end of the valve housing abutting a proximal side of the inlet/outlet plate, a distal side of the inlet/outlet plate abutting a proximal side of the fluid flow selector;
the inlet/outlet plate having first and second inlet openings and first and second outlet openings with the surface plate having corresponding inlet openings and outlet openings fluidly coupled to the corresponding first and second inlet openings and first and second outlet openings of the inlet/outlet plate;
the fluid flow selector having a fluid flow passage therein; and
the fluid flow selector rotatable with respect to the inlet/outlet plate among a plurality of rotational positions, the rotational positions including a closed position, a first open position and a second open position, the fluid flow passage bridging across only the first inlet opening to the first outlet opening when the fluid flow selector is in the first open position to fluidly couple the first inlet opening to the first outlet opening, the fluid flow passage bridging across only the second inlet opening to the second outlet opening to fluidly couple the second inlet opening to the second outlet opening when the fluid flow selector is in the second open position, and the fluid flow passage not bridging across the first inlet to the first outlet and not bridging across the second inlet to the second outlet when the fluid flow selector is in the closed position.

2. The multi-flow valve of claim 1 wherein the fluid flow passage is an offset arcuate channel in the fluid flow selector plate that is offset from a center of the fluid flow selector and that lies in an arc in which the first and second inlet openings and the first and second outlet openings of the inlet/outlet plate are disposed.

3. The multi-flow valve of claim 2 wherein the offset arcuate channel bridges across the first outlet opening to the second outlet opening to fluidly couple the first outlet opening to the second outlet opening when the fluid flow selector is in the closed position.

4. The multi-flow valve of claim 2 wherein the inlet/outlet plate includes third and fourth inlet openings and a mixed flow outlet opening, the fluid flow selector comprising a fluid flow selector plate having a mixed flow fluid passage comprising an elongate central channel in the fluid flow selector plate;
the fluid flow selector plate movable radially with respect to the inlet/outlet plate among at least an auxiliary flow position, a neutral flow position and a mixed-flow position;
the offset arcuate channel of the fluid flow selector plate lying in the arc in which the first and second inlet openings and the first and second outlet openings lie when the fluid flow selector plate is in the auxiliary flow position and the offset arcuate channel does not lie in this arc when the fluid flow selector plate is not in the auxiliary flow position and when the fluid flow selector plate is not in the auxiliary flow position the offset arcuate channel does not fluidly couple the first inlet opening to the first outlet opening, the second fluid opening to the second outlet opening or the first outlet opening to the second outlet opening regardless of the rotational position of the fluid flow selector plate;
the plurality of rotational positions among which the fluid flow selector plate can be rotated including when the fluid flow selector plate is in the mixed flow position a mixed flow on position in which a section of the elongate channel extends over the third and fourth fluid inlets and the elongate channel bridges across and the third and fourth fluid inlets to the mixed flow outlet opening to fluidly couple the third and fourth fluid inlets to the mixed flow outlet, a third flow on position in which the section of the elongate channel extends over the third inlet opening and the elongate channel bridges across the third fluid inlet opening and the mixed flow outlet opening to fluidly couple the third fluid inlet opening to the mixed flow outlet opening but does not bridge across the fourth flow inlet to the mixed flow outlet opening, and a fourth flow on position in which the section of the elongate channel extends over the fourth inlet opening and the elongate channel bridges across the fourth inlet opening to the mixed flow outlet opening to fluidly couple the fourth inlet opening to the mixed flow outlet opening but does not bridge across the third inlet opening to the mixed flow outlet opening; and
wherein when the fluid selector plate is in the neutral flow position none of the inlet openings and outlet openings are fluidly coupled to each other regardless of the rotational position of the fluid selector plate.

5. The multi-flow valve of claim 4 wherein the mixed flow position includes a plurality of mixed flow positions including a mixed flow-low volume position and a mixed flow-high volume position wherein when the fluid flow selector plate is in the mixed flow-high volume position a larger section of the elongate channel extends over those of the third and fourth inlet openings to which the fluid flow selector plate has been rotated to extend over than when the fluid flow selector plate is in the mixed flow-low volume position.

6. The multi-flow valve of claim 4 wherein when the fluid flow selector plate is in the closed position in the auxiliary flow position, the arcuate channel bridges across the first outlet opening to the second outlet opening to fluidly couple the first outlet opening to the second outlet opening.

7. The valve of claim 2 wherein the inlet/outlet plate includes third and fourth inlet openings and a mixed flow outlet opening, the fluid flow selector comprising inner and outer concentric disks that are each rotatable independently of each other with respect to the inlet/outlet plate, the outer concentric disk having the arcuate offset channel therein, the inner concentric disk having a mixed flow fluid passage comprising an elongate central channel in the fluid flow selector plate;
at least the inner concentric disk movable radially with respect to the inlet/outlet plate among at least a neutral flow position and a mixed-flow position;
the plurality of rotational positions among which the inner concentric disk can be rotated when the inner concentric disk is in the mixed flow position including a mixed flow on position in which a section of the elongate channel extends over the third and fourth fluid inlets and the elongate channel bridges across and the third and fourth fluid inlets to the mixed flow outlet opening to fluidly couple the third and fourth fluid inlets to the mixed flow outlet, a third flow on position in which the section of the elongate channel extends over the third inlet opening and the elongate channel bridges across the third fluid inlet opening and the mixed flow outlet opening to fluidly couple the third fluid inlet opening to the mixed flow outlet opening and does not bridge across the fourth flow inlet to the mixed flow outlet opening and a fourth flow on position in which the section of the elongate channel extends over the fourth inlet opening and the elongate channel bridges across the fourth inlet opening to the mixed flow outlet to fluidly couple the fourth inlet opening to the mixed flow outlet opening but does not bridge across the third inlet opening to the mixed flow outlet opening; and
wherein when the inner concentric disk is in the neutral flow position neither of the third and fourth inlet openings are fluidly coupled to the mixed flow outlet opening regardless of the rotational position of the fluid selector plate.

8. The valve of claim 7 wherein the mixed flow position includes a plurality of mixed flow positions including a mixed flow-low volume position and a mixed flow-high volume position wherein when the inner concentric disk is in the mixed flow-high volume position a larger section of the elongate channel extends over those of the third and fourth inlet openings to which the inner concentric disk has been rotated to extend over than when the inner concentric disk is in the mixed flow-low volume position.

9. The multi-flow valve of claim 7 wherein when the fluid selector is in the closed position the arcuate offset channel of the outer concentric disk bridges across the first outlet opening to the second outlet opening to fluidly couple the first outlet opening to the second outlet opening.

10. The multi-flow valve of claim 1 including interchangeable orifices received in the inlet openings of the surface plate wherein the interchangeable orifices are sized to provide a desired flow rate of fluid.

11. A multi-flow valve, comprising:
a valve housing in which a spindle, a fluid flow selector plate and an inlet/outlet plate are received and a surface plate affixed to a proximal end of the valve housing abutting a proximal side of the inlet/outlet plate, a distal side of the inlet/outlet plate abutting a proximal side of the fluid flow selector;
the inlet/outlet plate having first, second and third inlet openings and a first outlet opening and a mixed flow outlet opening with the surface plate having corresponding inlet openings and outlet openings fluidly coupled to the corresponding first, second and third inlet openings and first outlet opening and mixed flow outlet opening of the inlet/outlet plate;
the fluid flow selector plate having an offset arcuate channel therein;
the fluid flow selector rotatable with respect to the inlet/outlet plate among a plurality of rotational positions, the rotational positions including a closed position and a first open position, the offset arcuate channel bridging across the first inlet opening to the first outlet opening when the fluid flow selector is in the first open position to fluidly couple the first inlet opening to the first outlet opening and the offset arcuate channel not bridging across the first inlet to the first outlet when the fluid flow selector is in the closed position;
the fluid flow selector plate having a mixed flow fluid passage comprising an elongate central channel in the fluid flow selector;
the fluid flow selector plate movable radially with respect to the inlet/outlet plate among at least an auxiliary flow position, a neutral flow position and a mixed-flow position;
the offset arcuate channel of the fluid flow selector plate lying in an arc in which the first inlet opening and the first outlet opening lie when the fluid flow selector plate is in the auxiliary flow position and the offset arcuate channel does not lie in this arc when the fluid flow selector plate is not in the auxiliary flow position and when the fluid flow selector plate is not in the auxiliary flow position the offset arcuate channel does not fluidly couple the first inlet opening to the first outlet opening regardless of the rotational position of the fluid flow selector plate;
the plurality of rotational positions among which the fluid flow selector plate can be rotated including when the fluid flow selector plate is in the mixed flow position a mixed flow on position in which a section of the elongate channel extends over the second and third fluid inlets and the elongate channel bridges across and the second and third fluid inlets to the mixed flow outlet opening to fluidly couple the second and third fluid inlets to the mixed flow outlet, a second flow on position in which the section of the elongate channel extends over the second inlet opening and the elongate channel bridges across the second inlet opening and the mixed flow outlet opening to fluidly couple the second inlet opening to the mixed flow outlet opening but does not bridge across the third inlet opening to the mixed flow outlet opening, and a third flow on position in which the section of the elongate channel extends over the third inlet opening and the elongate channel bridges across the third inlet opening to the mixed flow outlet opening to fluidly couple the third inlet opening to the mixed flow outlet opening but does not bridge across the second inlet opening to the mixed flow outlet opening; and
wherein when the fluid selector plate is in the neutral flow position none of the inlet openings and outlet openings are fluidly coupled to each other regardless of the rotational position of the fluid selector plate.

12. The multi-flow valve of claim 11 wherein the mixed flow position includes a plurality of mixed flow positions including a mixed flow-low volume position and a mixed flow-high volume position wherein when the fluid flow selector plate is in the mixed flow-high volume position a larger section of the elongate channel extends over those of the second and third inlet openings to which the fluid flow selector plate has been rotated to extend over than when the fluid flow selector plate is in the mixed flow-low volume position.

13. A multi-flow valve, comprising:
a valve housing in which a spindle, a fluid flow selector and an inlet/outlet plate are received and a surface plate affixed to a proximal end of the valve housing abutting a proximal side of the inlet/outlet plate, a distal side of the inlet/outlet plate abutting a proximal side of the fluid flow selector;
the inlet/outlet plate having first, second and third inlet openings and a first outlet opening and a mixed flow outlet opening with the surface plate having corresponding inlet openings and outlet openings fluidly coupled to the corresponding first, second and third inlet openings and first outlet opening and mixed flow outlet opening of the inlet/outlet plate;
the fluid flow selector comprising inner and outer concentric disks that are each rotatable independently of each other with respect to the inlet/outlet plate, the outer concentric disk having an arcuate offset channel therein, the inner concentric disk having a mixed flow fluid passage comprising an elongate central channel in the fluid flow selector plate;
the outer concentric disk rotatable with respect to the inlet/outlet plate among a plurality of rotational positions, the rotational positions including a closed position and a first open position, the offset arcuate channel bridging across the first inlet opening to the first outlet opening when the fluid flow selector is in the first open position to fluidly couple the first inlet opening to the first outlet opening and the offset arcuate channel not bridging across the first inlet to the first outlet when the fluid flow selector is in the closed position;
at least the inner concentric disk movable radially with respect to the inlet/outlet plate among at least a neutral flow position and a mixed-flow position;
the plurality of rotational positions among which the inner concentric disk can be rotated when the inner concentric disk is in the mixed flow position including a mixed flow on position in which a section of the elongate channel extends over the third and fourth fluid inlets and the elongate channel bridges across the second and third inlet openings to the mixed flow outlet opening to fluidly couple the second and third inlet openings to the mixed flow outlet, a second flow on position in which the section of the elongate channel extends over the second inlet opening and the elongate channel bridges across the second inlet opening and the mixed flow outlet opening to fluidly couple the second inlet opening to the mixed flow outlet opening and does not bridge across the third inlet opening to the mixed flow outlet opening and a third flow on position in which the section of the elongate channel extends over the third inlet opening and the elongate channel bridges across the third inlet opening to the mixed flow outlet to fluidly couple the third inlet opening to the mixed flow outlet opening but does not bridge across the second inlet opening to the mixed flow outlet opening; and
wherein when the inner concentric disk is in the neutral flow position neither of the second and third openings are fluidly coupled to the mixed flow outlet opening regardless of the rotational position of the fluid selector plate.

14. The multi-flow valve of claim 13 wherein the mixed flow position includes a plurality of mixed flow positions including a mixed flow-low volume position and a mixed flow-high volume position wherein when the inner concentric disk is in the mixed flow-high volume position a larger section of the elongate channel extends over those of the second and third inlet openings to which the inner concentric disk has been rotated to extend over than when the inner concentric disk is in the mixed flow-low volume position.

15. A water dispenser comprising:
a conditioned water source, a multi-flow valve and a faucet spout;
the multi-flow valve including:
a valve housing in which a spindle, a fluid flow selector and an inlet/outlet plate are received and a surface plate affixed to a proximal end of the valve housing abutting a proximal side of the inlet/outlet plate, a distal side of the inlet/outlet plate abutting a proximal side of the fluid flow selector plate;
the inlet/outlet plate having first and second inlet openings and first and second outlet openings with the surface plate having corresponding first and second inlet openings and first and second outlet openings fluidly coupled to the corresponding first and second inlet openings and first and second outlet openings of the inlet/outlet plate, the first and second inlet openings of the surface plate providing provide first and second inlets of the valve and the first and second outlet openings of the surface plate providing first and second outlets of the valve;
the fluid flow selector having a fluid flow passage therein;
the fluid flow selector rotatable with respect to the inlet/outlet plate among a plurality of rotational positions, the rotational positions including a closed position, a first open position and a second open position, the fluid flow passage bridging across only the first inlet opening to the first outlet opening when the fluid flow selector is in the first open position to fluidly couple the first inlet opening to the first outlet opening, the fluid flow passage bridging across only the second inlet opening to the second outlet opening to fluidly couple the second inlet opening to the second outlet opening when the fluid flow selector is in the second open position, and the fluid flow passage not bridging across the first inlet to the first outlet and not bridging across the second inlet to the second outlet when the fluid flow selector is in the closed position; and
the first outlet of the valve fluidly coupled to the conditioned water source, the second outlet of the valve fluidly coupled to an outlet line of the faucet spout and an outlet of the water source fluidly coupled to the outlet line of the faucet spout.

16. The water dispenser of claim 15 further including a hot/cold water mixing valve and the faucet spout having a mixed water outlet line fluidly coupled to an outlet of hot/cold water mixing valve.

17. The water dispenser of claim 15 wherein the fluid flow passage is an offset arcuate channel in the fluid flow selector that is offset from a center of the fluid flow selector and that lies in an arc in which the first and second inlet openings and the first and second outlet openings of the inlet/outlet plate are disposed.

18. The water dispenser of claim 17 wherein the offset arcuate channel bridges across the first outlet opening to the second outlet opening to fluidly couple the first outlet opening to the second outlet opening when the fluid flow selector is in the closed position.

19. The water dispenser of claim 17 wherein the inlet/outlet plate includes third and fourth inlet openings and a mixed flow outlet opening, the fluid flow selector comprising a fluid flow selector plate having a mixed flow fluid passage comprising an elongate central channel in the fluid flow selector plate;
the fluid flow selector plate movable radially with respect to the inlet/outlet plate among at least an auxiliary flow position, a neutral flow position and a mixed-flow position;
the arcuate channel of fluid flow selector plate lying in the arc in which the first and second inlet openings and the first and second outlet openings lie when the fluid flow selector plate is in the auxiliary flow position and the offset arcuate channel does not lie in this arc when the fluid flow selector plate is not in the auxiliary flow position and when the fluid flow selector plate is not in the auxiliary flow position the offset arcuate channel does not fluidly couple the first inlet opening to the first outlet opening, the second fluid opening to the second outlet opening or the first outlet opening to the second outlet opening regardless of the rotational position of the fluid flow selector plate;
the plurality of rotational positions among which the fluid flow selector plate can be rotated including when the fluid flow selector plate is in the mixed flow position a mixed flow on position in which a section of the elongate channel extends over the third and fourth fluid inlets and the elongate channel bridges across and the third and fourth fluid inlets to the mixed flow outlet opening to fluidly couple the third and fourth fluid inlets to the mixed flow outlet, a third flow on position in which the section of the elongate channel extends over the third inlet opening and the elongate channel bridges across the third inlet opening and the mixed flow outlet opening to fluidly couple the third inlet opening to the mixed flow outlet opening but does not bridge across the fourth inlet opening to the mixed flow outlet opening, and a fourth flow on position in which the section of the elongate channel extends over the fourth inlet opening and the elongate channel bridges across the fourth inlet opening to the mixed flow outlet opening to fluidly couple the fourth inlet opening to the mixed flow outlet opening but does not bridge across the third inlet opening to the mixed flow outlet opening; and
wherein when the fluid selector plate is in the neutral flow position none of the inlet openings and outlet openings are fluidly coupled to each other regardless of the rotational position of the fluid selector plate.

20. The water dispenser of claim 19 wherein the mixed flow position includes a plurality of mixed flow positions including a mixed flow-low volume position and a mixed flow-high volume position wherein when the fluid flow selector plate is in the mixed flow-high volume position a larger section of the elongate channel extends over those of the third and fourth inlet openings to which the fluid flow selector plate has been rotated to extend over than when the fluid flow selector plate is in the mixed flow-low volume position.

21. The water dispenser of claim 19 wherein when the fluid flow selector plate is in the closed position in the auxiliary flow position, the arcuate channel bridges across the first outlet opening to the second outlet opening to fluidly couple the first outlet opening to the second outlet opening.

22. The water dispenser of claim 17 wherein the inlet/outlet plate includes third and fourth inlet openings and a mixed flow outlet opening, the fluid flow selector comprising inner and outer concentric disks that are each rotatable independently of each other with respect to the inlet/outlet plate, the outer concentric disk having the arcuate offset channel therein, the inner concentric disk having a mixed flow fluid passage comprising an elongate central channel in the fluid flow selector plate;
at least the inner concentric disk movable radially with respect to the inlet/outlet plate among at least a neutral flow position and a mixed-flow position;
the plurality of rotational positions among which the fluid flow selector plate can be rotated when the inner concentric disk is in the mixed flow position including a mixed flow on position in which a section of the elongate channel extends over the third and fourth fluid inlets and the elongate channel bridges across and the third and fourth fluid inlets to the mixed flow outlet opening to fluidly couple the third and fourth fluid inlets to the mixed flow outlet, a third flow on position in which the section of the elongate channel extends over the third inlet opening and the elongate channel bridges across the third fluid inlet opening and the mixed flow outlet opening to fluidly couple the third fluid inlet opening to the mixed flow outlet opening and does not bridge across the fourth flow inlet to the mixed flow outlet opening and a fourth flow on position in which the section of the elongate channel extends over the fourth inlet opening and the elongate channel bridges across the fourth inlet opening to the mixed flow outlet to fluidly couple the fourth inlet opening to the mixed flow outlet opening but does not bridge across the third inlet opening to the mixed flow outlet opening; and
wherein when the inner concentric disk is in the neutral flow position neither of the third and fourth inlet openings are fluidly coupled to the mixed flow outlet opening regardless of the rotational position of the fluid selector plate.

23. The water dispenser of claim 22 wherein the mixed flow position includes a plurality of mixed flow positions including a mixed flow-low volume position and a mixed flow-high volume position wherein when the inner concentric disk is in the mixed flow-high volume position a larger section of the elongate channel extends over those of the third and fourth inlet openings to which the inner concentric disk has been rotated to extend over than when the inner concentric disk is in the mixed flow-low volume position.

24. The water dispenser of claim 22 wherein when the fluid selector is in the closed position the arcuate offset channel of the outer concentric disk bridges across the first outlet opening to the second outlet opening to fluidly couple the first outlet opening to the second outlet opening.

25. The water dispenser of claim 15 including interchangeable orifices received in the inlet openings of the surface plate of the valve wherein the interchangeable orifices are sized to provide a desired flow rate of fluid.

26. A water dispenser, comprising:
a faucet spout and a multi-flow valve;
the multi-flow valve including:
a valve housing in which a spindle, a fluid flow selector and an inlet/outlet plate are received and a surface plate affixed to a proximal end of the valve housing abutting a proximal side of the inlet/outlet plate, a distal side of the inlet/outlet plate abutting a proximal side of the fluid flow selector plate;
the inlet/outlet plate having first and second inlet openings and first and second outlet openings with the surface plate having corresponding inlet openings and outlet openings fluidly coupled to the corresponding first and second inlet openings and first and second outlet openings of the inlet/outlet plate;
the first outlet opening of the surface plate fluidly coupled to a first water outlet line of the faucet spout and the second outlet opening of the surface plate fluidly coupled to either the first water outlet line or a second water outlet line of the faucet spout;
the fluid flow selector having a fluid flow passage therein; and
the fluid flow selector rotatable with respect to the inlet/outlet plate among a plurality of rotational positions, the rotational positions including a closed position, a first open position and a second open position, the fluid flow passage bridging across only the first inlet opening to the first outlet opening when the fluid flow selector is in the first open position to fluidly couple the first inlet opening to the first outlet opening, the fluid flow passage bridging across only the second inlet opening to the second outlet opening to fluidly couple the second inlet opening to the second outlet opening when the fluid flow selector is in the second open position, and the fluid flow passage not bridging across the first inlet to the first outlet and not bridging across the second inlet to the second outlet when the fluid flow selector is in the closed position.

27. The water dispenser of claim 26 wherein the fluid flow selector is a fluid flow selector plate and the fluid flow passage is an offset arcuate channel in the fluid flow selector plate that is offset from a center of the fluid flow selector plate and that lies in an arc in which the first and second inlet openings and the first and second outlet openings of the inlet/outlet plate are disposed.

28. The water dispenser of claim 27 wherein the offset arcuate channel bridges across the first outlet opening to the second outlet opening to fluidly couple the first outlet opening to the second outlet opening when the fluid flow selector is in the closed position.

29. The water dispenser of claim 26 including interchangeable orifices received in the inlet openings of the surface plate of the valve wherein the interchangeable orifices are sized to provide a desired flow rate of fluid.

30. The water dispenser of claim 28 wherein the first inlet opening of the surface plate is fluidly coupled to a hot tap water supply line and the second inlet opening of the surface plate is fluidly coupled to a cold tap water supply line.

31. The water dispenser of claim 26 wherein the first inlet opening of the surface plate is fluidly coupled to a source of conditioned water.

32. The water dispenser if claim 26 wherein the second inlet opening of the surface plate is fluidly coupled to a source of conditioned water.
